(19) United States
(12) Patent Application Publication
(10) Pub. No.: US 2004/0160163 A1
(43) Pub. Date: Aug. 19, 2004

(54) Electrified vacuum panel

(75) Inventors: Roberto Giannantonio, Oleggio (Novara) (IT); Alessandro Fumagalli, Cantu (Como) (IT); Gianluca Galliani, Milano (IT); Enea Rizzi, Milano (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES GETTERS S.p.A.

(21) Appl. No.: 10/782,623

(22) Filed: Feb. 19, 2004

Related U.S. Application Data
(63) Continuation of application No. PCT/IT03/00060, filed on Feb. 7, 2003.

(30) Foreign Application Priority Data
Feb. 18, 2002 (IT) MI2002A 000319

(51) Int. Cl. H01J 1/62; H01J 17/49

(52) U.S. Cl. 313/495; 313/634

(57) ABSTRACT

Vacuum panel comprising a discontinuous or porous filling material (5) enclosed between at least two barrier sheets (6) mutually joined along the edges, between which are gas-tightly arranged one or more rheophores (7, 7′) suitable for electrically powering at least one device (1, 2, 3, 3′, 4, 4′) arranged inside the vacuum panel, in particular a sensor for measuring the pressure (P) of the residual gases in the panel itself.

The present invention relates to an electrified vacuum panel, and in particular a vacuum panel comprising rheophores for powering electric or electronic devices arranged therein, as for example a sensor for measuring the vacuum.

It is known that the quality of vacuum panels depends upon the vacuum degree inside them, so that it is necessary, during the manufacture, to measure the pressure of the residual gases in several samples for evaluating their quality. The methods employed for this measurement use invasive devices and are generally carried out manually in laboratory, with following high costs and long duration. Moreover, because of its sampling nature, this quality control cannot exclude a single failure in a series of vacuum panels.

The object of the present invention is therefore to provide a vacuum panel free from these drawbacks, that is a vacuum panel wherein the vacuum degree can be controlled in short times and without tamperings. Said object is achieved with a vacuum panel, the main features of which are specified in claim 1, while other features are specified in the following claims.

Thanks to the particular electrification thereof, the panel according to the present invention can permanently house a sensor for carrying out quick and accurate measurements of the residual gas pressure.

Through this arrangement it is possible to determine rapidly and accurately the quality of the vacuum panels not only during their manufacture, but also after a long time from their installation, or periodically, so as to accomplish a continuous check.

Furthermore, the conductive bands used for the electrification can be easily manufactured and assembled together with the vacuum panels, since they are preferably made up with the same material used for the relevant barrier sheets, or with a material similar or compatible with the latter.

Further advantages and features of the vacuum panel according to the present invention will be clear to those skilled in the art from the following detailed and non-limiting description of one embodiment thereof with reference to the attached drawings wherein:

FIG. 1 shows a partial cross-sectional top view of the vacuum panel according to this embodiment of the invention;

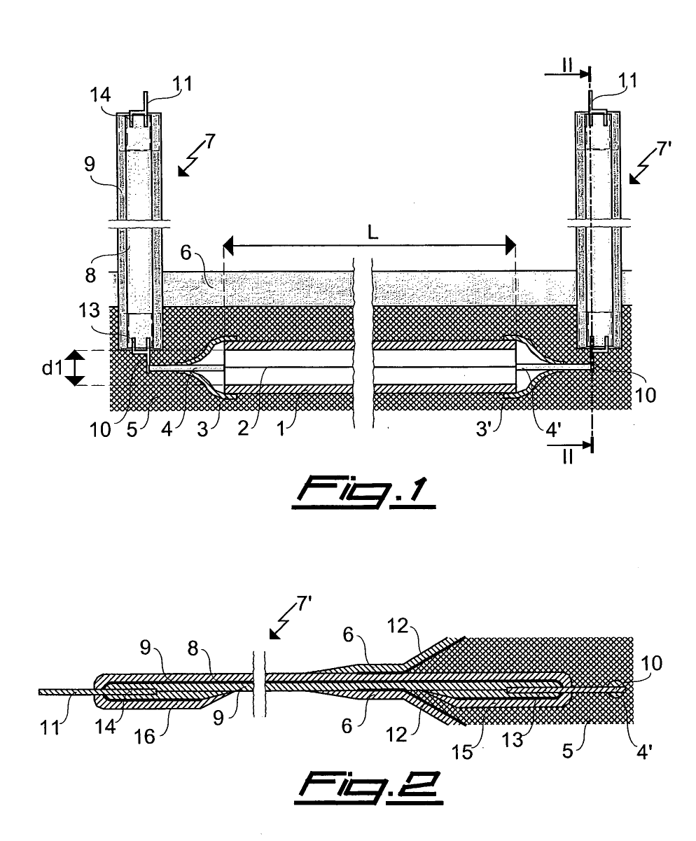

FIG. 2 shows an enlarged partial sectional view taken along plane II-II of the vacuum panel of FIG. 1; and

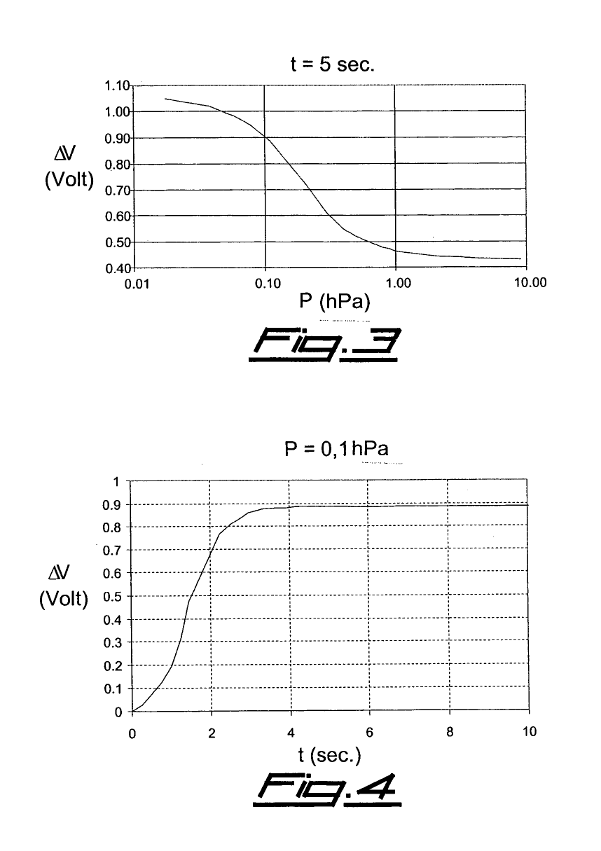

FIGS. 3 and 4 show two working diagrams of a pressure sensor arranged in the vacuum panel of FIG. 1.

Referring to FIG. 1, the vacuum panel according to the present embodiment of the invention includes internally a pressure sensor comprising a housing 1 preferably cylindrical-shaped, inside which a wire 2 of conductive material is arranged. The internal volume of housing 1 is much greater than the volume of wire 2; in particular, the internal diameter d₁ of housing 1 is much greater than diameter d₂ of wire 2, that is, d₁>>d₂. The interior of housing 1 is suitably connected to the interior of the vacuum panel so as to exchange gases with it. In particular, housing 1 is gas permeable and can be formed of a tube of a non-porous material, for example glass, which is provided of a plurality of holes, or of a tube of a porous material, for example ceramic or alumina. Wire 2 is preferably made up of nickel, platinum or tungsten, that is metals having a high temperature coefficient α_{T} of the resistance and a low emissivity ε_{f}. The ends of housing 1 are provided with two closing elements 3, 3′, for example substantially conical- or frustoconical-shaped. The external ends of the closing elements 3, 3′ are in turn crossed by two conductive terminals 4, 4′, in which are inserted the ends of wire 2, which is therefore taut in the middle of housing 1 in a preferably coaxial way, so as to be exposed to gases contained in housing 1 for a length L. Terminals 4, 4′ are preferably made up with a conductive material having a low thermal conductivity, such as steel.

In the present embodiment of the invention, the vacuum panel comprises in a known way a discontinuous or porous filling material 5 enclosed between two barrier sheets 6 mutually joined along the edges, for example by means of heat sealing.

Terminals 4, 4′ of the sensor are electrically connected to the outside through one or more rheophores 7, 7′ arranged between the barrier sheets 6. In particular, rheophores 7, 7′ are preferably formed of two conductive bands, both comprising a conductive layer 8 enclosed between two insulating layers 9 mutually joined along the edges, for example by means of heat sealing. The two ends of both conductive bands 7, 7′ are further provided with pins 10, 11, the former of which is soldered to a terminal 4 or 4′ and the latter is prepared for the connection with external apparatuses.

Referring now also to FIG. 2, in the present embodiment the conductive bands 7, 7′ comprise two insulating layers 9 formed of one or more tapes of polymeric material, in particular a heat sealable tape of high density polyethylene (HDPE) having a thickness comprised between 50 and 100 μm. Insulating layers 9 enclose a conductive layer 8 formed particularly of an aluminum tape having a thickness comprised between 4 and 10 μm. In other embodiments of the present invention layers 9 can be made up with other thermoplastic polymers, such as e.g. polyacrylonitrile (PAN), polyethylene terephthalate (PET), polyvinylchloride (PVC), polypropylene (PP) or other polymers, as well as mixtures and copolymers thereof, while conductive layer 8 can be made up with other conductive metals, such as copper, gold and silver, or with conductive polymers, such as iodine-doped polyacetylene. Conductive layer 8 is inserted between insulating layers 9 by means of colamination, preferably carried out by arranging between layers 8 and 9 an adhesive material, such as epoxidic, cyanoacrylic, polyurethanic, etc. resins. Alternatively, when the currents crossing conductive bands 7, 7′ are low, it is possible to produce these latter by joining together two polymeric films acting as insulating layers 9, at least one of which has a metallized surface which is comprised between these films and acts as the conductive layer 8.

In the present embodiment of the invention the conductive bands 7, 7′ are arranged between the two barrier sheets 6 of the vacuum panel before they are sealed along their edges. The sealing of the edges of the barrier sheets 6 occurs preferably by means of heat sealing, hence, since these sheets are made up with materials identical, similar or in any case compatible with those used for the insulating layers 9 of the conductive bands 7, 7′, the latter are soldered between the barrier sheets 6, thereby forming a perfect gas-tight joining while avoiding possible current dispersions or short-circuits with the metallic or metallized layer 12 which may occur on the internal surface of the barrier sheets 6.

Pins 10, 11 are preferably inserted in a substantially perpendicular way through the conductive bands 7, 7′ during the manufacture thereof, so as to pierce layers 8, 9 and to accomplish an electric connection with the conductive layer 8. For this purpose, pins 10, 11 are joined to metallic members, particularly clamps 13, 14 provided with tips crossing the conductive bands 7, 7′. Once the tips of clamps 13, 14 have been inserted into the conductive bands 7, 7′, the borders 15, 16 of these latter included between their ends and clamps 13, 14 are folded and heat sealed onto the same bands, so as to enclose and insulate the tips of clamps 13, 14. With this arrangement, pins 10, 11 protrude freely outwards and are at the same time steadily locked along the same plane of the conductive bands 7, 7′.

In other embodiments of the present invention, the conductive bands 7, 7′ can comprise two or more conductive layers 8 electrically separated from one another, for example arranged side by side between the insulating layers 9 or arranged one on the other and separated by a further insulating layer 9. With this arrangement it is possible to use only one conductive band to electrify the vacuum panel or to send several signals in parallel to electric or electronic devices arranged inside the panel. With these conductive bands, but also with those previously described, it is possible to use terminal boards comprising two or more pins suitable for piercing the ends of the insulating and conductive layers, thus obtaining the electric connection with the electric or electronic devices inside and/or outside the vacuum panel.

Wire 2 is powered through the conductive bands 7, 7′ with an external power unit (not shown in the drawings) which supplies a constant current I=I₂. When at time t=0 the current starts flowing along wire 2, the latter becomes hot due to the Joule effect. If pressure P of the residual gases in housing 1 is relatively low, in particular lower than 0.1 hecto-Pascal (hPa), the thermal exchange due to these gases is very modest and the temperature of wire 2 increases progressively from the initial value Tᵢ up to a high final value T_{f}, which stabilizes when the dissipated thermal power Q_{f,G}, depending upon the thermal gradient between wire 2 and the gas mass inside housing 1, is equal to the electric power Qₑ supplied from the outside through the conductive bands 7, 7′. If pressure P of the residual gases in housing 1 is relatively high, in particular higher than 1 hPa, when current I₂ starts to flow along wire 2, the mechanisms of the thermal exchange of convective type which keep the final temperature T_{f} of wire 2 substantially equal to the initial temperature Tᵢ, are immediately established.

Therefore, at low pressures P, wire 2 comes to the stationary conditions absorbing the maximum electric power Qₑ and revealing the maximum potential drop ΔV at its ends, since the electrical resistance R of the wire increases at high temperatures T_{f}. On the contrary, at high pressures P, the electric resistance R and the temperature T_{f}, and consequently the absorbed electric power Qₑ and the potential drop ΔV, are at minimum values.

FIG. 3 shows a diagram from which it can be seen how the variation of the potential difference ΔV at the ends of wire 2, measured in stationary conditions, varies according to pressure P of the residual gases present in housing 1, that is, in the vacuum panel.

FIG. 4 shows instead a diagram from which it can be seen how the potential difference ΔV measured at the ends of wire 2 develops during the time at a pressure P of the residual gases equal to 0.1 hPa. As it can be seen, the stationary conditions are reached very quickly, in particular in a period of about 5 sec, which thus results to be the time required for measuring the pressure.

In the present embodiment of the invention, wire 2 is powered by an external device capable to supply an electric current I₂ constant in time and to measure at the same time the potential difference ΔV at the ends of wire 2, that is, of pins 11. In this case, the electric power Qₑ supplied to wire 2 in stationary conditions results to be a function of pressure P and of the final temperature Tf, since Qₑ=R(T_{f})×I₂² and the temperature T_{f} reached in stationary conditions depends upon mechanisms of thermal exchange, and thus also upon pressure P.

It is thus clear that, by keeping an electric power Qₑ constant or in any case determinable through the measurement of the potential difference ΔV at the ends of wire 2, that is, of pins 11, it is possible to obtain the pressure P of the residual gases present in the vacuum panel.

Possible changes and/or additions may be made to the embodiment of the invention here described and illustrated without departing from the scope of the same invention.

1. A vacuum panel comprising a discontinuous or porous filling material (5) enclosed between at least two barrier sheets (6) mutually joined along the edges, characterized in that one or more rheophores (7, 7′) suitable for electrically powering at least one device (1, 2, 3, 3′, 4, 4′) arranged inside the vacuum panel are gas-tightly arranged between the barrier sheets (6).

2. A vacuum panel according to claim 1, characterized in that the rheophores (7, 7′) are formed of a conductive band comprising at least a conductive layer (8) enclosed between at least two insulating layers (9).

3. A vacuum panel according to claim 2, characterized in that the insulating layers (9) are mutually joined along the edges.

4. A vacuum panel according to claim 2 or 3, characterized in that the insulating layers (9) comprise one or more tapes of a polymeric material identical, similar or compatible with the material of the barrier sheets (6).

5. A vacuum panel according to claim 4, characterized in that the insulating layers (9) comprise a heat sealable tape of high density polyethylene (HDPE).

6. A vacuum panel according to one of claims 2 to 5, characterized in that the insulating layers (9) have a thickness comprised between 50 and 100 μm.

7. A vacuum panel according to one of claims 2 to 6, characterized in that the conductive layer (8) comprise an aluminum tape.

8. A vacuum panel according to one of claims 2 to 7, characterized in that the conductive layer (8) has a thickness comprised between 4 and 10 μm.

9. A vacuum panel according to one of claims 2 to 6, characterized in that the conductive bands (7, 7′) comprise two polymeric films acting as insulating layers (9), at least one of which has a metallized surface which is comprised between said films and acts as a conductive layer (8).

10. A vacuum panel according to one of claims 2 to 9, characterized in that the conductive bands (7, 7′) are sealed together with the edges of the barrier sheets (6) of the vacuum panel by means of heat sealing.

11. A vacuum panel according to one of claims 2 to 10, characterized in that one or both ends of the conductive bands (7, 7′) are provided with pins (10, 11) for the connection to devices arranged outside and/or inside the vacuum panel.

12. A vacuum panel according to claim 11, characterized in that the pins (10, 11) cross the conductive bands (7, 7′) accomplishing an electric connection with the conductive layer (8).

13. A vacuum panel according to claim 12, characterized in that the pins (10, 11) are joined to clamps (13, 14) provided with tips which cross the conductive bands (7, 7′) and are arranged between the borders (15, 16) of the conductive bands (7, 7′) included between their ends and the same clamps (13, 14), which are folded and heat sealed onto the bands (7, 7′), so as to enclose and insulate the tips of the clamps (13, 14).

14. A vacuum panel according to one of the previous claims, characterized in that the device (1, 2, 3, 3′, 4, 4′) arranged inside the vacuum panel comprises a sensor for measuring the pressure (P) of the residual gases in the panel itself.

15. A vacuum panel according to claim 14, characterized in that the sensor comprises a housing (1) which is connected with the internal of the vacuum panel and encloses a wire (2) of conductive material suitable for being crossed by an electric current (I₂) and becoming hot due to the Joule effect.

16. A vacuum panel according to claim 15, characterized in that the housing (1) is gas permeable.

17. A vacuum panel according to claim 15 or 16, characterized in that the housing (1) has a substantially cylindrical shape of diameter d₁>>d₂, where d₂ is the diameter of the wire (2).

18. A vacuum panel according to claim 17, characterized in that the ends of the housing (1) are provided with two closing elements (3, 3′) crossed by two conductive terminals (4, 4′) wherein the ends of wire (2) are inserted so as to result taut in the middle of the housing (1) in a coaxial way.
